(19) United States
(12) Patent Application Publication
(10) Pub. No.: US 2002/0117969 A1
(43) Pub. Date: Aug. 29, 2002

(54) Magnetic shielding devices and methods involving active cancellation of external magnetic fields at the column of a charged-particle-beam optical system

(75) Inventors: Shohei Suzuki, Hukaya-shi (JP); Motofusa Kageyama, Yokohama-shi (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/002,908

(22) Filed: Nov. 13, 2001

(30) Foreign Application Priority Data
Feb. 28, 2001 (JP) 2001-055487
Apr. 26, 2001 (JP) 2001-128749

(51) Int. Cl. H01J 5/02

(52) U.S. Cl. 315/85

(57) ABSTRACT

Shielding devices and methods are disclosed for canceling the effects of external magnetic fields that otherwise would interfere with proper functioning of a charged-particle-beam (CPB) optical system inside a column. In one embodiment, openings and other disruptions in the continuity of the column are flanked by respective coil sets. Each coil set includes multiple coils that are individually electrically energized. The coils can be inside the column, outside the column, or both inside and outside. The magnitude and direction of the respective composite magnetic fields generated by the coil sets can be changed by adjusting the respective electrical currents flowing through the individual coils. Thus, the magnitude and direction of the composite magnetic field can be manipulated as required to cancel the effects of the interfering magnetic field. In addition, the column can be situated within a shield of an anisotropic magnetic material in which the magnetic flux most readily flows in selected directions. Thus, the flux of an external magnetic field that otherwise would leak into a column is caused to become aligned, in a respective portion of the shield, in the axial direction, thereby reducing its horizontal component.

### FIELD

This disclosure pertains, inter alia, to microlithography, which is a key technology employed in the fabrication of microelectronic devices such as integrated circuits, displays, thin-film magnetic pickup heads, and micromachines. More specifically, the disclosure pertains to microlithography performed using a charged particle beam such as an electron beam or ion beam. Even more specifically, the disclosure pertains to apparatus and methods for achieving magnetic shielding of a charged-particle-beam (CPB) optical system as used, e.g., in a CPB microlithography system, especially magnetic shielding that achieves satisfactory cancellation of magnetic fields external to a column containing the CPB optical system and/or of magnetic fields flowing on the outer skin of the column that otherwise would penetrate into the column and interfere with the trajectory of the charged particle beam in the column.

### BACKGROUND

Because a charged particle beam (e.g., electron beam or ion beam) cannot be transmitted satisfactorily through air, charged-particle-beam (CPB) optical systems are encased in a “columnn” that is evacuated to a suitably high vacuum. The column normally is contiguous with a vacuum chamber in which other components, such as a stage on which a lithographic substrate (e.g., semiconductor wafer) is mounted. In conventional CPB microlithography systems, the problem of magnetically shielding the CPB optical system is well known, and various approaches have been considered for achieving satisfactory protection of the CPB optical system inside the column from being adversely affected by external static and dynamic magnetic fields.

In one conventional approach, the column and vacuum chamber are enclosed in one or multiple layers of a material having a high initial permeability (such as one of the Permalloys). In addition, the column and/or vacuum chamber itself is made of Permalloy.

An example of an electron-beam microlithography apparatus having conventional magnetic shielding is shown in FIG. 9. The apparatus of FIG. 9 comprises column 11 encasing an electron-optical system (not detailed). The column 11 is contiguous with a vacuum chamber 12. The respective interiors of the column 11 and vacuum chamber 12 are evacuated by a vacuum pump (not shown) connected to a vacuum port 13. Inside the column 11 is an electron source 14 (e.g., electron gun) that produces an electron beam 15. The electron beam 15 is shaped and deflected as required by electron lenses and deflectors (not shown but well understood in the art) of the electron-optical system. Inside the vacuum chamber 12 is a substrate stage 16. Situated externally to the column 11 and vacuum chamber 12 is a magnetic shield 17 made of a material having a high initial permeability.

The column 11 typically defines various openings 18 to allow access inside the column for, e.g., evacuating the column (and vacuum chamber 12), making electrical connections to components (e.g., lenses and deflectors of the electron-optical system) inside the column 11, and for moving articles into and out of the column and vacuum chamber. In a system configuration as shown in FIG. 9, corresponding openings 19 also are defined in the magnetic shield 17. Having to provide these openings 19 in the shield 17 results in the shield 17 being divided into multiple segments or portions. These openings 18, 19 as well as any non-magnetic portions of the column 11 define respective “gaps” through which a stray or external magnetic field can enter the column. As used herein, the term “opening” encompasses any of various physical openings as well as any of various gaps.

Dividing the shield 17, having to define openings 19 in it, or otherwise providing gaps in the shield 17 inevitably degrade its shielding properties. Thus, in conventional systems utilizing this approach, it simply is not possible to provide a suitably high level of shielding, especially for a CPB optical system for use in a CPB microlithography apparatus. According to a conventional approach for improving the magnetic isolation of the charged particle beam inside the column, the entire room or area in which the CPB microlithography system is placed is completely enclosed in magnetic-shielding material, thereby forming a “shielded room.” Simply shielding a room in this manner represents a “passive” approach to room shielding.

In the shielded-room approach, the actual room shielding can be “active,” wherein coils (capable of generating respective magnetic fields in desired directions) are placed at a distance (e.g., in or on room walls) from the column and vacuum chamber. By selectively adjusting the magnitude and direction of electrical current delivered to individual coils, the coils produce respective magnetic fields that “cancel” the external magnetic fields. A magnetic-shielding device employing coils in this manner is referred to as an “active canceler.” An example of a conventional active canceler is shown in FIG. 10, comprising three pairs of coils 21 and 21′, 22 and 22′, and 23 and 23′, each indicated by a respective circle in the figure. Each coil is associated with a respective wall of a room or analogous space. The arrows associated with each circle denote the respective direction of electrical current flowing in the respective coil. Thus, the three pairs of coils 21 and 21′, 22 and 22′, and 23 and 23′ generate three respective magnetic fields oriented in respective mutually perpendicular directions. The individual electrical currents applied to the coils can be adjusted as required to obtain, in the active canceler, respective magnetic fields of the proper magnitude and direction to cancel the external fields.

Unfortunately, in the conventional active-canceler scheme summarized above, in which the column is covered with magnetic-shielding material, the constraints imposed by the need to define openings and/or gaps in the shielding material and/or by the need to divide the shielding into multiple portions make it impossible to achieve adequate shielding. Also, whenever the column is situated in a poor magnetic environment, or whenever the column is especially sensitive to external magnetic fields, double or triple shielding must be used in addition to placing the CPB microlithography apparatus in a shielded room. Such extensive shielding greatly increases both the mass of the CPB microlithography system and the floor area required to accommodate the system, which substantially increases cost.

The conventional active-canceler approach summarized above is effective for shielding a CPB microlithography system having a simple shape, such as a simple cylinder. However, CPB microlithography systems typically have more complex shapes. Furthermore, the external magnetic field often is highly non-uniform. Under either or both these conditions, the conventional active-canceler approach has limited utility in achieving satisfactory cancellation of external magnetic fields, and thus is incapable of reducing external magnetic fields in the column to within specifications. As a result, obtaining a desired magnetic-field distribution within the column is extremely difficult.

### SUMMARY

In view of the shortcomings of conventional apparatus and methods as summarized above, an object of the invention is to provide magnetic shielding methods and devices, as used especially in charged-particle-beam (CPB) microlithography systems and other systems that utilize a CPB optical system, for canceling the effects within the CPB optical system of otherwise interfering external magnetic fields. The subject methods and devices can be used in systems in which the column and/or chamber of the CPB optical system has a complex shape, and/or under conditions in which the external magnetic fields are highly non-uniform.

To such end, and according to a first aspect of the invention, methods are provided for magnetically shielding a CPB optical system situated inside a column that extends along an optical axis. In an embodiment of such a method one step involves disposing, at an axial position relative to the column, an active-canceler coil “set” adjacent a wall of the column so as not to obstruct a trajectory of a charged particle beam propagating in the column. The coil set can comprise as few as one coil or can comprise multiple individual coils that are individually electrically energizable. Another step involves electrically energizing the coil(s) so as to cause the coil set to produce a respective magnetic field of a desired direction and magnitude effective for canceling an external magnetic field or a magnetic flux, present externally to the column, that otherwise would extend from outside the column to the optical axis. Thus, a distribution of magnetic field within the column is corrected to a desired distribution. In the method, if the column defines a lateral opening (or other “gap” such as a region of non-magnetic material in the column), then the coil set desirably is disposed adjacent the opening.

If the coil set referred to above is regarded as a first coil set, then the method summarized above can further include disposing a second active-canceler coil “set” adjacent the opening opposite the first coil set so as not to obstruct the trajectory of a charged particle beam propagating in the column. The second coil set can comprise a single coil or can comprise multiple individual coils that are individually electrically energizable. While electrically energizing the coil(s) of the first coil set, the coil(s) of the second coil set are electrically energized so as to cause the coil sets to collectively produce a magnetic field of a desired direction and magnitude effective for canceling the external magnetic field.

The individual coil(s) of the coil set(s) can have any of various geometrical configurations. By way of example, each of the individual coils can be circular or rectilinear in configuration.

The coil set(s) can be situated in respective transverse plane(s) perpendicular to the optical axis or in respective plane(s) that are oblique relative to the optical axis.

By placing the coil(s) of a coil set at the same axial position relative to the column and by energizing the coil(s) with respective prescribed electrical currents, the magnitude and direction of the composite magnetic field generated by the coil(s) are controlled so as to controllably reduce penetration of an external magnetic field (or a magnetic flux on or near the outer surface of the column) into the optical path of the charged particle beam in the column. Desirably, the magnitude and direction of the interfering magnetic field(s) (e.g., the external field or the flux along the outer surface of the column) are measured, and the respective electrical currents in the individual coil(s) are adjusted as required to form a composite field that cancels the external field(s).

Interfering magnetic fields usually exhibit variation in the axial direction of the column. Hence, it is desirable to provide multiple coil sets at different respective axial positions relative to the column to allow cancellation of interfering magnetic fields at the various axial locations.

Because very precise cancellation of external fields can be achieved, the effects of interfering external magnetic fields can be adequately cancelled, even whenever the distribution of the interfering magnetic field is not uniform. Also, because this cancellation is achieved using coils, no extra space is required for shielding. This reduces the amount of space occupied by the CPB optical system and reduces the mass of the system.

It is noted that “cancellation” per se, as used herein, does not necessarily mean totally reducing the interfering field to zero magnitude. Rather, “cancellation” includes any reduction of the effects of the interfering magnetic field(s) at target locations to levels that will not pose problems with the system configuration.

In another method embodiment, one step involves disposing, at an axial position relative to the column and adjacent the opening (or other “gap”), an active-canceler coil set adjacent a wall of the column so as not to obstruct a trajectory of a charged particle beam propagating in the column. The coil set comprises at least one coil that is electrically energizable. In another step, a magnetic shield is disposed externally to the column. The magnetic shield desirably is made of an anisotropic magnetic material. The at least one coil is electrically energized so as to cause the coil set to produce a respective magnetic field of a desired direction and magnitude effective for canceling an external magnetic field or a magnetic flux, present externally to the column, that otherwise would extend from outside the column through the opening to the optical axis. Thus, a distribution of magnetic field within the column is corrected to a desired distribution. In this method embodiment, the coil(s) can have any of various respective configurations such as any of the specific configurations as summarized above. Furthermore, the magnetic shield desirably is magnetically partitioned, with the partitions desirably extending in the axial direction.

If anisotropic magnetic material is used for the magnetic shield, then the direction of the external (and possibly interfering) magnetic field can be altered to align its direction with the direction of the magnetic field generated by the coils. As a result, controlling the respective electrical currents applied to the coils to achieve the desired cancellation is correspondingly made easier, even whenever the shape of the CPB optical system is complex and/or the external magnetic field(s) is highly non-uniform.

In practice, the coil set(s) and the anisotropic direction and location of the magnetic shield material are determined such that the direction and magnitude of the external magnetic field are opposite the direction and magnitude of the composite magnetic field produced by the electrical currents flowing through the respective coils.

According to yet another method embodiment, at least one active-canceler coil set is situated on or near the column so as not to obstruct a trajectory of a charged particle beam propagating in the column. Each coil set is configured, when electrically energized, to produce a respective magnetic field oriented in a prescribed direction. The at least one coil set is electrically energized to cause the coil set to produce the respective magnetic field having a magnitude sufficient to cancel at least a portion of a target magnetic field, external to the column, that otherwise would penetrate through the column to the optical axis. The at least one coil set can be oriented relative to the column to produce a respective magnetic field having a direction parallel to the optical axis, perpendicular to the optical axis, or oblique relative to the optical axis.

Yet another embodiment is directed to a method for magnetically shielding a CPB system comprising a CPB column and at least one chamber situated relative to an optical axis. In the method, at an optical axial position relative to the system, at least one active canceler coil is disposed adjacent a wall of the system so as not to obstruct a trajectory of a charged particle beam propagating in the system. The at least one coil is electrically energized so as to cause the coil to produce a magnetic field. The produced magnetic field cancels at least a portion of an external magnetic field or a magnetic flux, present externally to the system and that otherwise would extend from outside to inside the system to the optical axis within the system, to a desired distribution. If the system defines a magnetic gap (which can be an opening in the CPB column), then the coil(s) desirably is defined adjacent the magnetic gap.

This method embodiment can include the step of disposing a magnetic shield externally to the system. The magnetic shield desirably is made of an anisotropic magnetic material, and can be magnetically partitioned into partitions. If the shield is partitioned, the partitions can extend, for example, in an axial direction. The magnetic shield can be disposed so as to place the magnetic flux, present externally to the system, in a desired direction along the optical axis.

The coil(s) can be oriented relative to the column to produce a respective magnetic field having any of various directions, such as parallel to the optical axis, obliquely to the optical axis, or perpendicular to the optical axis. If multiple coils are used, they can be positioned so as to position the optical axis within each coil or outside each coil.

According to another aspect of the invention, devices are provided, in the context of a CPB optical system situated inside a column, for reducing (by cancellation) a magnetic field external to the column that otherwise would extend to inside the column. Thus, the CPB optical system is magnetically shielded from the external magnetic field. An embodiment of such a device comprises an active-canceler coil set situated at an axial position relative to the column and adjacent a wall of the column so as not to obstruct a trajectory of a charged particle beam propagating in the column. The coil set comprises at least one electrically energizable coil that produces, when electrically energized, a respective magnetic field of a direction and magnitude sufficient for canceling at least a portion of the external magnetic field. In this device embodiment, the coil(s) can have any of various configurations such as those summarized above.

In another embodiment, a magnetic-field-canceling device comprises an active-canceler coil set situated at an axial position relative to the column and adjacent a wall of the column so as not to obstruct a trajectory of a charged particle beam propagating in the column. The coil set comprises at least one coil that, when electrically energized, produces a respective magnetic field of a direction and magnitude sufficient for canceling at least a portion of the external magnetic field. The device also includes a magnetic shield, desirably made of an anisotropic magnetic material, situated outside the column. In this device embodiment, the coil(s) can have any of various specific configurations, as summarized above. Also, the device can include multiple coil sets. Furthermore, the magnetic shield can be magnetically partitioned, with the partitions desirably extending in the axial direction. Partitioning allows better alignment of the direction of the external magnetic field with the direction of the magnetic field formed by the respective currents flowing in the coils.

In yet another embodiment, the device comprises at least one active-canceler coil set situated on or near the column so as not to obstruct a trajectory of a charged particle beam propagating in the column. Each coil set is configured to be electrically energized and, when electrically energized, to produce a respective magnetic field oriented in a prescribed direction and having a magnitude sufficient to cancel at least a portion of the external magnetic field. The at least one coil set is oriented relative to the column to produce a respective magnetic field having a direction that is parallel to the optical axis, perpendicular to the optical axis, or oblique relative to the optical axis. This device can include a magnetic shield, as summarized above.

Yet another embodiment is directed to a device for magnetically shielding a CPB system comprising a CPB column and at least one chamber situated relative to an optical axis. At an optical axial position relative to the system, at least one active canceler coil is disposed adjacent a wall of the system so as not to obstruct a trajectory of a charged particle beam propagating in the system. The at least one coil is electrically energizable so as to cause the coil to produce a magnetic field. The produced magnetic field cancels at least a portion of an external magnetic field or a magnetic flux, present externally to the system and that otherwise would extend from outside to inside the system to the optical axis within the system, to a desired distribution. If the system defines a magnetic gap (which can be an opening in the CPB column), then the coil(s) desirably is defined adjacent the magnetic gap.

The device can include a magnetic shield disposed externally to the system. The magnetic shield desirably is made of an anisotropic magnetic material, and can be magnetically partitioned into partitions. If the shield is partitioned, the partitions can extend, for example, in an axial direction. The magnetic shield can be disposed so as to place the magnetic flux, present externally to the system, in a desired direction along the optical axis.

The coil(s) can be oriented relative to the column to produce a respective magnetic field having any of various directions, such as parallel to the optical axis, obliquely to the optical axis, or perpendicular to the optical axis. If multiple coils are used, they can be positioned so as to position the optical axis within each coil or outside each coil.

In any of the various device embodiments according to the invention one or more magnetic sensors can be employed for sensing the magnitude and direction of an external magnetic field. For example, a magnetic sensor can be situated at a location where a magnetic field having zero magnitude is required or desired. Respective electrical currents supplied to individual coils of a coil set(s) can be controlled, based on feedback from the sensor(s), to achieve the goal of complete cancellation of the external magnetic field According to another aspect of the invention, CPB microlithography apparatus are provided that include a device as summarized above.

The foregoing and additional features and advantages of the invention will be more readily apparent from the following detailed description, which proceeds with reference to the accompanying drawings.

### BRIEF DESCRIPTION OF THE DRAWINGS

FIG. 1(a) is an elevational section of a column and contiguous vacuum chamber of a CPB optical system that includes a first representative embodiment of a device for canceling an external magnetic field.

FIGS. 1(b) and 1(c) are respective transverse sections of the column of FIG. 1(a), showing respective configurations of active-canceler coil sets each comprising multiple individual coils situated outside the column.

FIG. 2(a) is an elevational section of the column and contiguous vacuum chamber of a CPB optical system that includes a second representative embodiment of a device for canceling an external magnetic field.

FIGS. 2(b) and 2(c) are respective transverse sections of the column of FIG. 2(a), showing respective configurations of active-canceler coil sets each comprising multiple individual coils situated inside the column.

FIG. 3(a) is an elevational section of the column and contiguous vacuum chamber of a CPB optical system that includes a third representative embodiment of a device for canceling an external magnetic field.

FIGS. 3(b)-3(c) are respective transverse sections of the column of FIG. 3(a), showing respective configurations of active-canceler coil sets each comprising multiple individual coils situated inside the column.

FIG. 4 is an elevational section of the column and contiguous vacuum chamber of a CPB optical system that includes a fourth representative embodiment of a device for canceling an external magnetic field.

FIG. 5 is an oblique view of external magnetic shielding around a column and vacuum chamber, according to a fifth representative embodiment.

FIG. 6 is an elevation section of the column and vacuum chamber of a CPB optical system that includes a sixth representative embodiment of a device for canceling an external magnetic field.

FIG. 7(a) is an elevational section of the column and vacuum chamber of a CPB optical system that includes a seventh representative embodiment of a device for canceling an external magnetic field.

FIG. 7(b) depicts a plan view (in the x-y plane) and an elevational view (in the y-z plane) of a coil of the coil set 105 shown in FIG. 7(a).

FIG. 7(c) is an oblique view of the coil shown in FIG. 7(b).

FIG. 8 is an elevational section of the column and vacuum chamber of a CPB optical system that includes an eighth representative embodiment of a device for canceling an external magnetic field.

FIG. 9 is an elevational section of a column and contiguous vacuum chamber that include external magnetic shielding according to a conventional shielding scheme.

FIG. 10 is an oblique view of certain aspects of a conventional active-canceler scheme for shielding a room or analogous space containing a CPB optical system.

### DETAILED DESCRIPTION

Various aspects of the invention are described below in the context of representative embodiments, which are not intended to be limiting in any way.

First Representative Embodiment

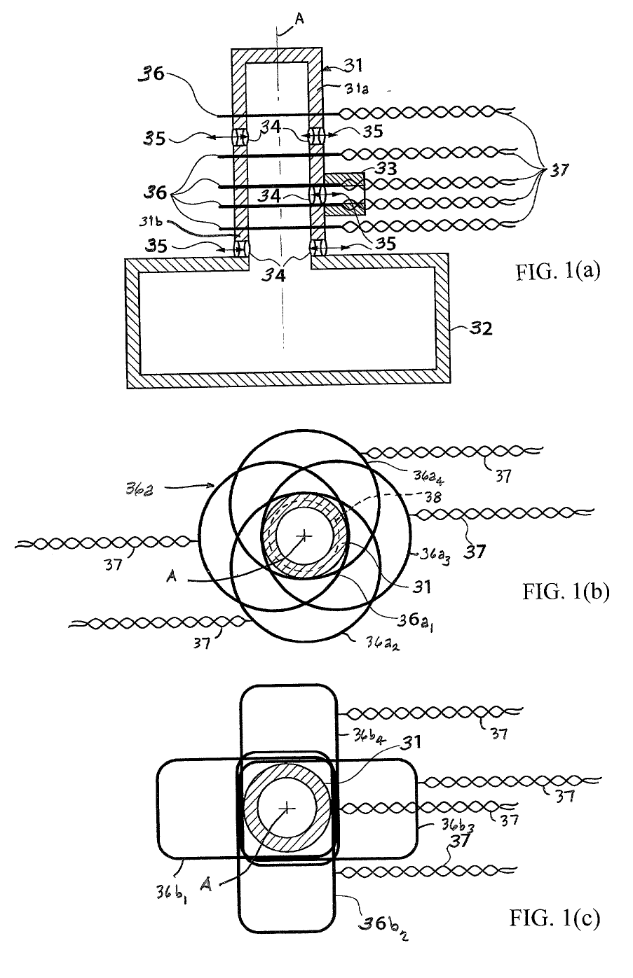

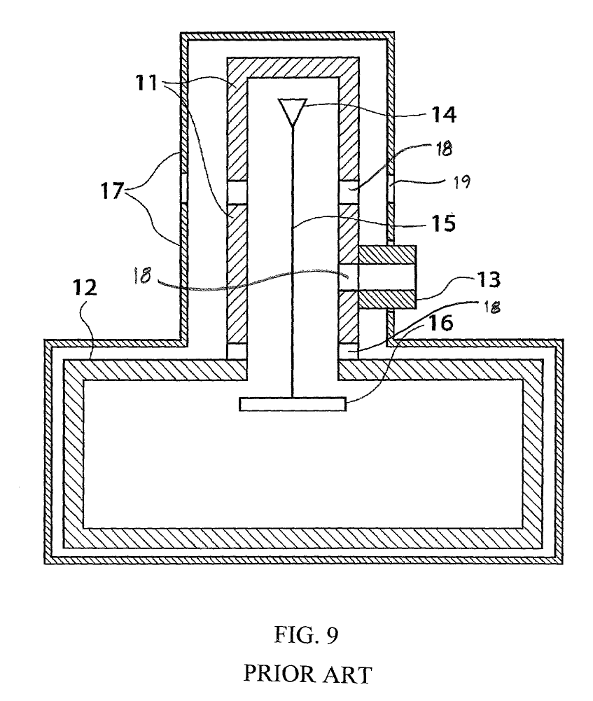

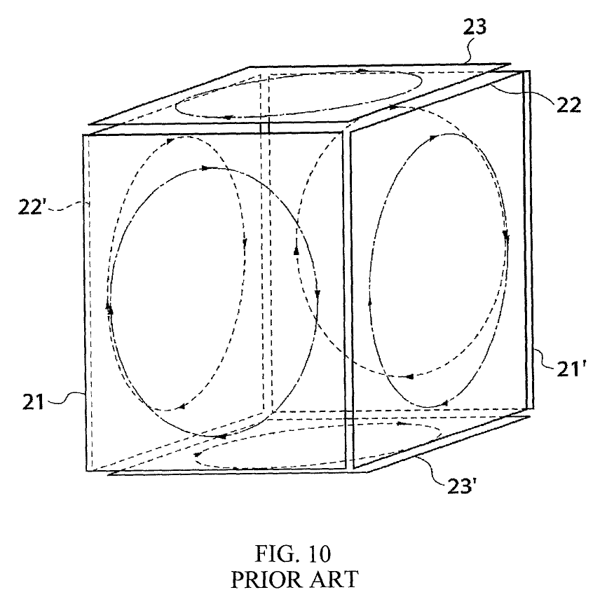

Magnetic shielding according to this embodiment is described with reference to FIGS. 1(a)-1(c), which depict an electron-optical system (as a representative CPB optical system). Similar to the configuration shown in FIG. 9, the embodiment of FIG. 1(a) comprises a column 31 that contains an electron-optical system (not shown) comprising, e.g., electron lenses and deflectors. Contiguous with the column 31 is a vacuum chamber 32 that, together with the column 31, is connected to a vacuum pump (not shown) via a vacuum port 33.

The column 31 comprises multiple portions 31a, 31b and defines various openings 34 at which external magnetic fields (indicated by arrows 35) can leak into the column 31. The openings 34 can be actual physical openings or “gaps” defined by respective regions of non-magnetic material through which stray or external magnetic fields can enter the column 31. Whereas these external fields could disrupt the trajectory of the electron beam in the column 31, they are prevented from having such an effect by active-canceler coil sets 36 (e.g., a total of five coil sets) placed proximally to the openings 34.

Exemplary coil sets 36a and 36b are shown in FIGS. 1(b) and 1(c), respectively. Each of FIGS. 1(b) and 1(c) is a respective view along the longitudinal axis A of the column 31, which results in the column 31 being viewed as a transverse section. The coil set 36a shown in FIG. 1(b) comprises four individual circular coils 36a₁-36a₄. The coils 36a₁-36a₄ are situated at the same position along the axis A of the column 31 and are situated outside and encircle the column 31. The center of each coil 36a₁-36a₄ is laterally displaced from the center of the column 31, wherein the respective centers of the coils 36a₁-36a₄ are situated on a circle 38 equi-angularly (90° in the depicted configuration) relative to each other. The circle 38 is concentric with the longitudinal axis A. Each of the coils 36a₁-36a₄ has a respective pair of wires 37 extending therefrom. To minimize external effects of magnetic fields generated by the currents flowing therein, each pair of wires 37 is twisted. As an alternative to twisted pairs of wires 37, shielded cable or twisted pairs with shielding could be used.

Because the four coils 36a₁-36a₄ are situated with offset centers as noted above, the magnitude and direction of the composite magnetic field generated by the set of coils 36a can be finely varied over a wide range by adjusting the respective electrical current flowing in each individual coil 36a₁-36a₄. Thus, a composite magnetic field can be generated having a magnitude and direction sufficient to cancel an otherwise interfering external magnetic field, thereby canceling the effect of the external magnetic field.

In the coil set 36b shown in FIG. 1(c), each of the individual coils 36b₁-36b₄ has an oblong configuration. However, the operational result of the coil set 36b is the same as of the coil set 36a in FIG. 1(b).

Second Representative Embodiment

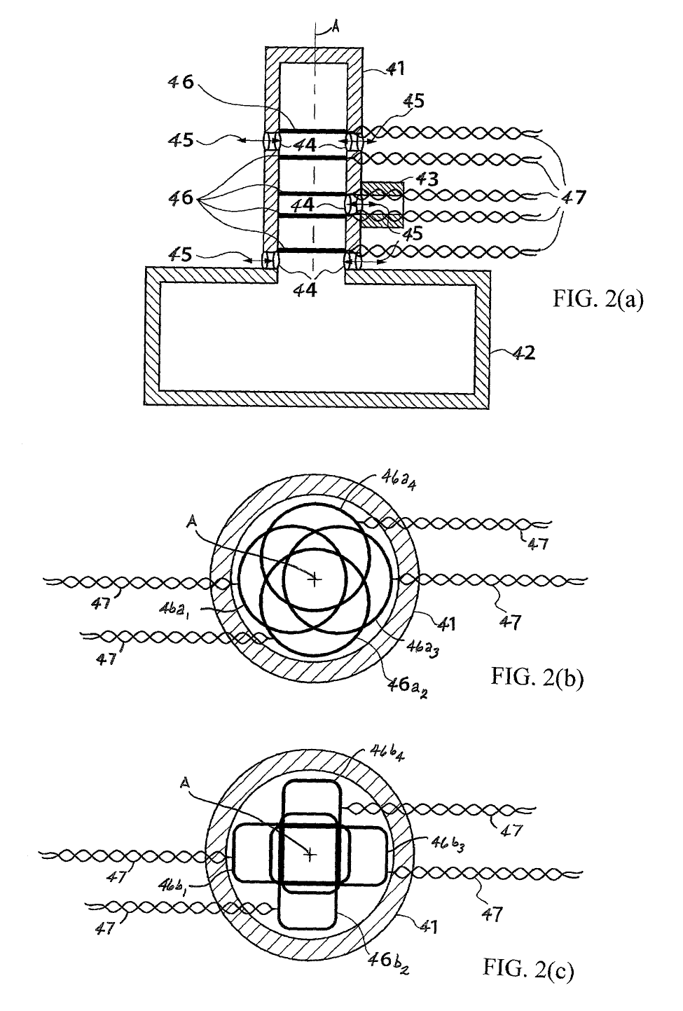

Magnetic shielding according to this embodiment is described with reference to FIGS. 2(a)-2(c), which depict an electron-optical system (as a representative CPB optical system). Similar to the first representative embodiment, the embodiment of FIG. 2(a) comprises a column 41 that contains an electron-optical system (not shown). Contiguous with the column 41 is a vacuum chamber 42 that, together with the column 41, is connected to a vacuum pump (not shown) via a vacuum port 43.

The column 41 defines various openings (or gaps) 44 at which external magnetic fields (indicated by arrows 45) can leak into the column 41. Whereas these external fields could disrupt the trajectory of the electron beam in the column 41, they are prevented from having such an effect by active-canceler coil sets 46 (e.g., a total of five coil sets placed in a manner similar to the first representative embodiment).

Exemplary coil sets 46a and 46b are shown in FIGS. 2(b) and 2(c), respectively. Each of FIGS. 2(b) and 2(c) is a respective view along the longitudinal axis A of the column 41, which results in the column 41 being viewed as a transverse section. The coil set 46a shown in FIG. 2(b) comprises four individual circular coils 46a₁-46a₄. The coils 46a₁-46a₄ are situated inside the column 41 at the same position along the axis A. The center of each coil 46a₁-46a₄ is laterally displaced from the center of the column 41, wherein the respective centers of the coils 46a₁-46a₄ are situated equi-angularly (90° in the depicted configuration) relative to each other. Each of the coils 46a₁-46a₄ has a respective pair of wires 47 extending therefrom. To minimize external effects of magnetic fields generated by the currents flowing therein, each pair of wires 47 is twisted, as discussed in the first representative embodiment.

Because the four coils 46a₁-46a₄ are situated with offset centers as noted above, the magnitude and direction of the composite magnetic field generated by the set of coils 46a can be finely varied over a wide range by adjusting the respective electrical current flowing in each individual coil 46a₁-46a₄. Thus, a composite magnetic field can be generated having a magnitude and direction sufficient to cancel an otherwise interfering external magnetic field, thereby canceling the effect of the external magnetic field.

In the coil set 46b shown in FIG. 2(c), each of the individual coils 46b₁-46b₄ has an oblong configuration. However, the operational result of the coil set 46b is the same as of the coil set 46a in FIG. 2(b).

The placement of coils in the configurations of FIGS. 2(b) and 2(c) shares many similarities to the placement scheme of the first representative embodiment, except that, in the first representative embodiment the coils 36 are outside the column 31, and in the second representative embodiment the coils 46 are inside the column 41. Nevertheless, so long as the active-canceler coils 46 do not obstruct the trajectory of the electron beam, the placement of coils 46 as shown in FIGS. 2(b) and 2(c) functions as well as the placement of coils 36 in FIGS. 1(b) and 1(c). Also, by mounting the coils 46 inside the column 41 according to the second representative embodiment, the respective magnetic fields generated by the coils 46 are not impeded by having to pass through the column 41. As a result, smaller currents can be applied to the coils 46 to control the composite magnetic field.

Third Representative Embodiment

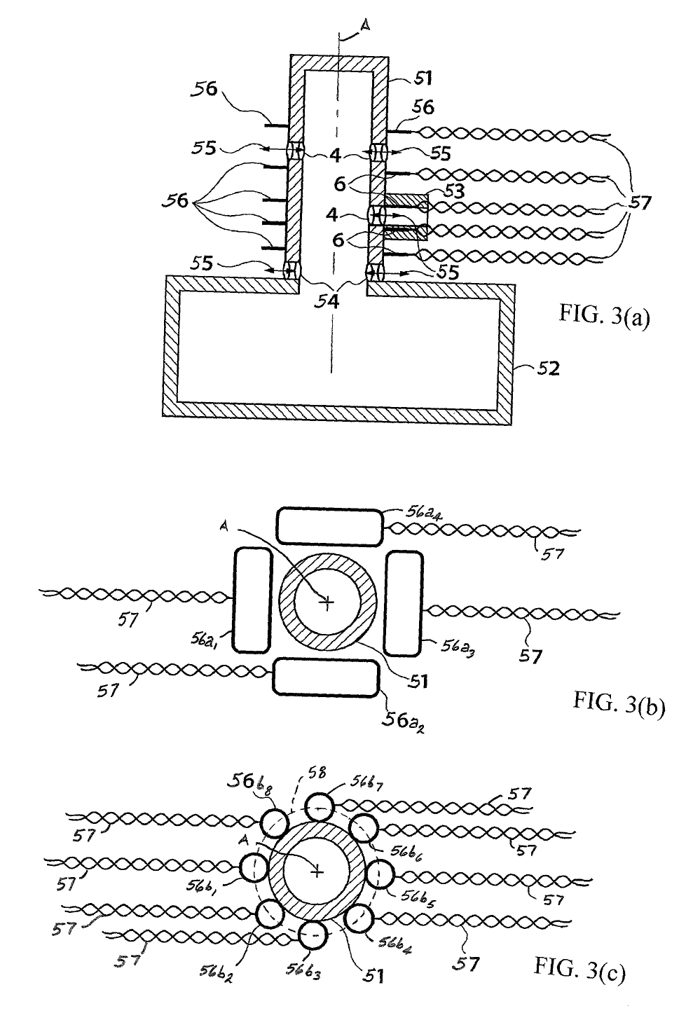

Magnetic shielding according to this embodiment is described with reference to FIGS. 3(a)-3(c), which depict an electron-optical system (as a representative CPB optical system). Similar to the first representative embodiment, the embodiment of FIG. 3(a) comprises a column 51 that contains an electron-optical system (not shown). Contiguous with the column 51 is a vacuum chamber 52 that, together with the column 51, is connected to a vacuum pump (not shown) via a vacuum port 53.

The column 51 defines various openings (or gaps) 54 at which external magnetic fields (indicated by arrows 55) can leak into the column 51. Whereas these external fields could disrupt the trajectory of the electron beam in the column 51, they are prevented from having such an effect by active-canceler coil sets 56 (e.g., a total of five coil sets placed in a manner similar to the first representative embodiment).

Exemplary coil sets 56a and 56b are shown in FIGS. 3(b) and 3(c), respectively. Each of FIGS. 3(b) and 3(c) is a respective view along the longitudinal axis A of the column 51, which results in the column 51 being viewed as a transverse section.

The coil set 56a shown in FIG. 3(b) comprises four individual oblong coils 56a₁-56a₄. The coils 56a₁-56a₄ are situated outside the column 51 at the same position along the axis A. The center of each coil 56a₁-56a₄ is laterally displaced from the center of the column 51, wherein the respective centers of the coils 56a₁-56a₄ are situated equi-angularly (90° in the depicted configuration) relative to each other. Each of the coils 56a₁-56a₄ has a respective pair of wires 57 extending therefrom. To minimize external effects of magnetic fields generated by the currents flowing therein, each pair of wires 57 is twisted, as discussed in the first representative embodiment.

Because the four coils 56a₁-56a₄ are situated with offset centers as noted above, the magnitude and direction of the composite magnetic field generated by the set of coils 56a can be finely varied over a wide range by adjusting the respective electrical current flowing in each individual coil 56a₁-56a₄. Thus, a composite magnetic field can be generated having a magnitude and direction sufficient to cancel an otherwise interfering external magnetic field, thereby canceling the effect of the external magnetic field.

The coil set 56b shown in FIG. 3(c) comprises eight individual coils 56b₁-56b₈. Each of the individual coils 56b₁-56b₈ has a circular configuration, and the coils 56b₁-56b₈ are arranged equi-angularly relative to each other on a circle 58 outside the column 51. However, the operational result of the coil set 56b is the same as of the coil set 56a in FIG. 3(b).

For cancellation of an actual interfering magnetic field, a combination of two or more of the first, second, and third representative embodiments can be utilized.

In the first, second, and third representative embodiments, the coils 36, 46, and 56, respectively, are all in respective transverse planes that are perpendicular to the axis A. Alternatively, all or some of these coils can be placed at an incline relative to the respective transverse planes (e.g., see the eighth representative embodiment).

Also, in the first, second, and third representative embodiments, the coils 36, 46, 56 are situated relative to the respective column at respective positions that are within the scope of the phrase “on or near” the respective column.

With the first, second, and third representative embodiments, very accurate and precise cancellation of an external magnetic field can be achieved, even under conditions in which the distribution of the external magnetic field is not uniform. Also, because this cancellation is achieved using coils situated on or near the respective columns, no extra space is required for shielding, which reduces the mass and volume of shielding that actually is used.

Fourth Representative Embodiment

The first, second, and third representative embodiments are effective for canceling the effects of external magnetic fields. However, if (1) components of the external magnetic field have a direction parallel to the axis A as well as transverse to the axis A, (2) the external magnetic field has a complex profile, or (3) the external magnetic field is highly non-uniform, then extremely precise and complex control of the respective electrical currents in the individual coils is required to achieve satisfactory cancellation of the effects of such fields and a desired distribution of magnetic field within the column. For example, a situation could arise in which an external magnetic field extending in the axial direction is effectively canceled, but another external magnetic field extending transversely to the axis is not sufficiently canceled. This fourth representative embodiment is configured to address a situation such as one of these.

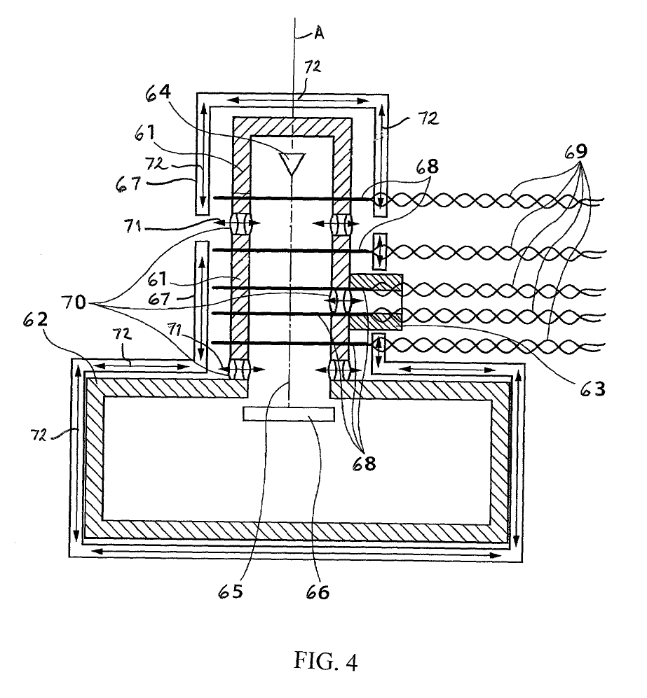

Reference is made to FIG. 4, in which are depicted a column 61, a vacuum chamber 62, a vacuum port 63, an electron-beam source 64 (that produces an electron beam 65), a substrate stage 66, magnetic shields 67, active-canceler coil sets 68 (with corresponding connecting wires 69), openings (or gaps) 70 in the column 61, and an external magnetic field (arrows 71).

In the depicted configuration, the active-canceler coil sets 68 (a total of five sets) are situated proximally to the openings 70 in the column 61. Thus, the active-canceler coil sets 68 are situated in a manner similar to the first, second, and third representative embodiments.

The magnetic shield 67 comprises an anisotropic magnetic material (such as grain-oriented silicon steel). The shield 67 is configured such that the direction having the least resistance to magnetic flux is as indicated by the arrows 72. By configuring the magnetic shield 67 in this manner, the direction of an external magnetic field leaking into the column 61 can be aligned with a component of the field extending in the direction of the optical axis A (vertical direction in the figure), thereby reducing the component of the field extending in the transverse direction (horizontal direction in the figure). Effective cancellation of the component of the field extending in the axial direction can be achieved primarily through the action of the active-canceler coil sets 68. The reduction of the transverse component (to which the sensitivity of the charged particle beam 65 is high) eases achieving the desired control of the external field because it allows attention to be given to canceling the magnetic field in the axial direction (to which the sensitivity of the beam 65 is low).

Fifth Representative Embodiment

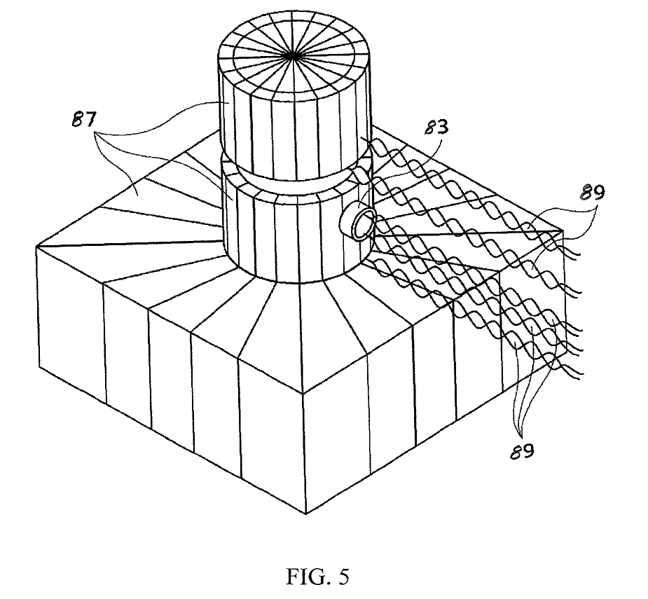

This embodiment is depicted in FIG. 5. A system according to this embodiment is configured similarly to the fourth representative embodiment, except that, instead of using an anisotropic magnetic material for the magnetic shield 87, a magnetic-shielding material such as Permalloy is used. The shield material is magnetically partitioned as shown in the figure to provide the most unobstructed flow of magnetic flux in the axial direction in the shield 87. Thus, the same operational effect is obtained as in the fourth representative embodiment (FIG. 4).

In a CPB optical system especially as used in a CPB microlithography system, the effect of a lateral magnetic field on system performance is about 100 times greater than the effect of an axially oriented magnetic field. Hence, in this representative embodiment, the shield 87 is configured to achieve high suppression of lateral magnetic fields, and the effects of axially oriented magnetic fields are reduced by active-canceler coils such as in any of the first, second, third, and fourth representative embodiments. As an alternative, if conditions dictate, the axially oriented fields can be suppressed using the external magnetic shield 87, and reduction of the effects of the transverse fields is achieved using the active-canceler coils.

Thus, in any event, the effects of external magnetic fields in both the axial and transverse directions are controllably reduced. Since transversely oriented fields tend to have higher magnitude in regions where gaps are larger (such as at the substrate stage), this representative embodiment can be most effective when applied at these locations.

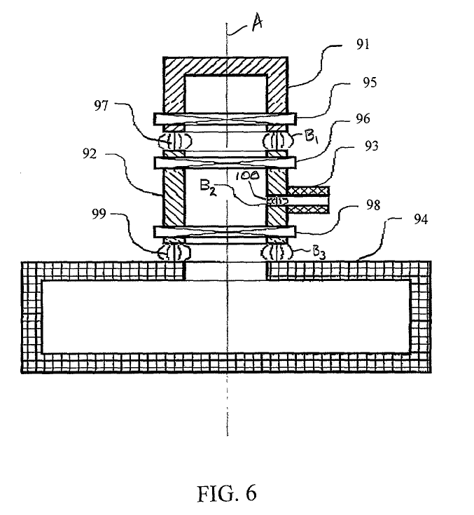

If the material of the shield 87 is partitioned according to this representative embodiment, gaps will exist between adjacent segments of the shielding material. Because these gaps can be a source of direct leakage of magnetic flux through the gaps directly into the CPB optical system inside the column, the gaps should be kept as small as possible. Leakage of magnetic flux can be essentially eliminated by keeping these gaps less than approximately 0.5 mm wide. Direct leakage of flux through the gaps also can be reduced by staggering the gaps (i.e., offsetting their positions relative to each other), and by configuring the shield as a laminate of multiple layers of shielding material, thereby enhancing the overall shielding effect Sixth Representative Embodiment This embodiment is shown in FIG. 6. The depicted system includes an illumination-optical-system (IOS) column 91, an exposure-optical-system (EOS) column 92, a vacuum port 93, and a vacuum chamber 94. The columns 91, 92 typically extend along an axis A. The embodiment also includes active-canceler coil sets 95, 96 associated with an opening (or gap) 97 between the columns 91, 92, and an active-canceler coil set 98 associated with an opening (or gap) 99 between the column 92 and the vacuum chamber 94. The vacuum port 93 has an associated opening (or gap) 100. The axis A can be regarded as the optical axis of the depicted system and as the z-axis of a three-dimensional coordinate system. In the figure, “horizontal” is the left-right axis (e.g. x-axis), and “vertical” is the up-down axis (z-axis).

Without the coils sets 95, 96, 98, external magnetic fields could penetrate through the openings 97, 99, 100 into the interior of the columns 91, 92 and vacuum chamber 94 toward the axis A, potentially disrupting proper operation of the depicted CPB optical system. In this embodiment penetration of external magnetic fields is prevented by appropriate energization of the active-canceler coil sets 95, 96, 98. Each of the coil sets 95, 96, 98 extends in a respective plane (x-y plane) perpendicular to the axis A. The coil set 95 is situated on the IOS column 91 proximally to the opening 97; the coil set 96 is situated on the EOS column 92 proximally to the opening 97; and the coil set 98 is situated on the EOS column 92 proximally to the opening 99. Respective electrical currents supplied to the coil sets 95, 96, 98 create respective magnetic fields B₁, B₂, B₃ that extend parallel to the axis A that cancel external magnetic fields (magnetic flux) flowing in the opposite direction externally to the columns. Each of the three coil sets 95, 96, 98 in FIG. 6 is driven by a separate respective power supply (not shown) capable of adjusting the individual coil currents as required to minimize incursion of the external magnetic fields into the columns.

Seventh Representative Embodiment

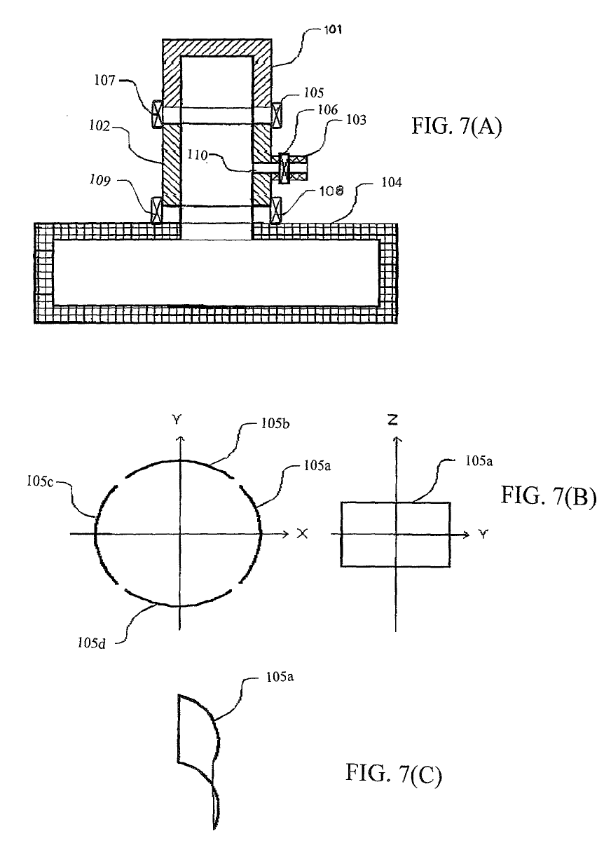

This embodiment is shown in FIGS. 7(a)-7(c). The depicted system includes an illumination-optical-system (IOS) column 101, an exposure-optical-system (EOS) column 102, a vacuum port 103, and a vacuum chamber 104. The columns 101, 102 typically extend along the axis A. The embodiment also includes an active-canceler coil set 105 associated with an opening (or gap) 107 between the columns 101, 102, an active-canceler coil set 106 associated with an opening (or gap) 110 into the vacuum port 103, and an active-canceler coil set 108 associated with an opening (or gap) 109 between the column 102 and the vacuum chamber 104. The axis A can be regarded as the optical axis of the depicted system, wherein the optical axis is parallel to a z-axis of a three-dimensional coordinate system.

Without the coil sets 105, 106, 108 external magnetic fields could penetrate through the openings 107, 109, 110 into the interior of the columns 101, 102 and vacuum chamber 104 toward the axis A, potentially disrupting proper operation of the depicted CPB optical system. In this embodiment penetration of external magnetic fields is prevented by appropriate energization of the active-canceler coil sets 105, 106, 108 associated with the respective openings 107, 109, 110 (FIG. 7(a)). Each of the coil sets 105, 106, 108 is configured to generate (when electrically energized) a respective magnetic field extending horizontally in the figure (i.e., in the x-axis and y-axis directions perpendicularly to the axis A). Electrical energization is performed by respective power supplies (not shown) capable of adjusting the individual coil currents as required to minimize incursions of the external magnetic fields to the charged particle beam inside the columns.

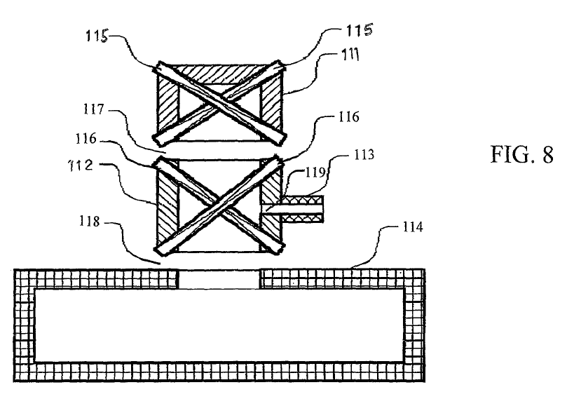

FIG. 7(b) shows a transverse (x-y plane) section of the coil set 105 and an elevational view of the coil 105a in the y-z plane. An oblique view of the coil 105a is shown in FIG. 7(c). As shown, the coil set 105 comprises four individual coils 105a-105d. The coils 105a and 105c generate respective magnetic fields extending in the x-axis direction, and the coils 105b and 105d generate respective magnetic fields extending in the y-axis direction. By individually controlling the respective electrical currents delivered to the coils 105a-105d, the resulting magnetic fields produced by the coils can be configured to cancel a horizontal external magnetic field. The configuration of the coil set 108 of FIG. 7(a) is essentially the same as the depicted configuration of the coil set 105. The coil set 106 is wound around the vacuum port 103 in a manner sufficient to generate a magnetic field in the x-axis direction (which is the axial direction of the vacuum port 103). Eighth Representative Embodiment This embodiment is depicted in FIG. 8. The depicted system includes an illumination-optical-system (IOS) column 111, an exposure-optical-system (EOS) column 112, a vacuum port 113, and a vacuum chamber 114. The columns 111, 112 typically extend along the axis A. The columns 111, 112 are separated from each other by an opening (or gap) 117, and the column 112 and vacuum chamber 114 are separated from each other by an opening (or gap) 118. Another opening (or gap) 119 is associated with the vacuum port 113. The embodiment also includes an active-canceler coil set 115 associated with the IOS column 111, and an active-canceler coil set 116 associated with the EOS column 112. The axis A can be regarded as the optical axis of the depicted system, wherein the optical axis is parallel to a z-axis of a three-dimensional coordinate system.

As shown in FIG. 8, each of the coil sets 115, 116 is wound diagonally on the respective column 111, 112 of the illumination-optical system and exposure-optical system, respectively. Respective electrical currents flowing in the coil sets cause the coils in the coil sets to generate magnetic fields, outside the respective columns, extending in respective directions that are oblique to the axis A. Thus, whenever an external magnetic flux is present that extends obliquely to the axis A, the coil sets 115, 116 effectively cancel the external magnetic flux and hence remove any deleterious effects of the external magnetic field.

The sixth, seventh, and eighth representative embodiments described above provide additional examples of coil sets being located “on or near” the respective columns. The respective coil sets in these embodiments cancel external magnetic fields extending in the z-axis direction (FIG. 6), in the x- and y-axis directions (FIG. 7(a)), and in directions oblique to the z-axis direction (FIG. 8). Hence, whenever it is desired to cancel external magnetic fields having directional components extending in multiple axial directions, the configurations of FIGS. 6, 7(a), and 8 can be combined to achieve effective cancellation of the three-dimensional external fields. Even more effective shielding can be achieved by including an external shield such as shown in FIG. 4 or FIG. 5.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A method for magnetically shielding a charged-particle-beam optical system situated inside a column that extends along an optical axis, the method comprising:
at an axial position relative to the column, disposing an active-canceler coil set adjacent a wall of the column so as not to obstruct a trajectory of a charged particle beam propagating in the column, the coil set comprising at least one coil that is individually electrically energizable; and
electrically energizing the coil set so as to cause the coil set to produce a respective magnetic field of a desired direction and magnitude effective for canceling at least a portion of an external magnetic field or a magnetic flux, present externally to the column, that otherwise would extend from outside the column to the optical axis, thereby correcting a distribution of magnetic field within the column to a desired distribution.

2. The method of claim 1, wherein the coil set comprises a single coil.

3. The method of claim 1, wherein the coil set comprises multiple individual coils.

4. The method of claim 1, wherein:
the column defines a lateral opening; and
the coil set is disposed adjacent the opening.

5. The method of claim 4, wherein the coil set is a first coil set, the method further comprising the steps of:
disposing a second active-canceler coil set adjacent the opening opposite the first coil set so as not to obstruct the trajectory of a charged particle beam propagating in the column, the second coil set comprising at least one coil that is individually electrically energizable; and
while electrically energizing the first coil set, electrically energizing the second coil set so as to cause the coil sets to collectively produce a magnetic field of a desired direction and magnitude effective for canceling the external magnetic field.

6. The method of claim 1, wherein:
the coil set comprises multiple individual coils; and
each of the individual coils is rectilinear in configuration.

7. The method of claim 1, wherein the coil set is situated in a transverse plane perpendicular to the optical axis.

8. A method for magnetically shielding a charged-particle-beam optical system situated inside a column that defines an opening and extends along an optical axis, the method comprising:
at an axial position relative to the column and adjacent the opening, disposing an active-canceler coil set adjacent a wall of the column so as not to obstruct a trajectory of a charged particle beam propagating in the column, the coil set comprising at least one coil that is electrically energizable;
disposing a magnetic shield externally to the column, the magnetic shield being made of an anisotropic magnetic material; and
electrically energizing the coil set so as to cause the coil set to produce a respective magnetic field of a desired direction and magnitude effective for canceling at least a portion of an external magnetic field or a magnetic flux, present externally to the column, that otherwise would extend from outside the column through the opening to the optical axis, thereby correcting a distribution of magnetic field within the column to a desired distribution.

9. The method of claim 8, wherein the coil set is a first coil set, the method further comprising the steps of:
disposing a second active-canceler coil set adjacent the opening opposite the first coil set so as not to obstruct the trajectory of a charged particle beam propagating in the column, the second coil set comprising at least one coil that is individually electrically energizable; and
while electrically energizing the first coil set, electrically energizing the second coil set so as to cause the coil sets to collectively produce a magnetic field of a desired direction and magnitude effective for canceling at least a portion of the external magnetic field.

10. The method of claim 8, wherein the magnetic shield is magnetically partitioned.

11. The method of claim 10, wherein the partitions extend in the axial direction.

12. A method for magnetically shielding a charged-particle-beam optical system situated inside a column that extends along an optical axis, the method comprising:
situating at least one active-canceler coil set on or near the column so as not to obstruct a trajectory of a charged particle beam propagating in the column, each coil set being configured, when electrically energized, to produce a respective magnetic field oriented in a prescribed direction; and
electrically energizing the at least one coil set to cause the coil set to produce the respective magnetic field having a magnitude sufficient to cancel at least a portion of a target magnetic field, external to the column, that otherwise would penetrate through the column to the optical axis.

13. The method of claim 12, wherein the at least one coil set is oriented relative to the column to produce a respective magnetic field having a direction parallel to the optical axis.

14. The method of claim 12, wherein the at least one coil set is oriented relative to the column to produce a respective magnetic field having a direction that is oblique relative to the optical axis.

15. The method of claim 12, wherein the at least one coil set is oriented relative to the column to produce a respective magnetic field having a direction that is perpendicular to the optical axis.

16. In a charged-particle-beam (CPB) optical system situated inside a column that extends along an optical axis, a device for reducing, by cancellation, a magnetic field external to the column that otherwise would extend to inside the column, so as to magnetically shield the CPB optical system from the external magnetic field, the device comprising an active-canceler coil set situated at an axial position relative to the column and adjacent a wall of the column so as not to obstruct a trajectory of a charged particle beam propagating in the column, the coil set comprising at least one electrically energizable coil that, when electrically energized, produces a respective magnetic field of a direction and magnitude sufficient for canceling at least a portion of the external magnetic field.

17. The device of claim 16, wherein:
the column defines a lateral opening; and
the coil set is disposed adjacent the opening.

18. The device of claim 17, wherein the coil set is a first coil set, the device further comprising a second active-canceler coil set situated adjacent the opening opposite the first coil set so as not to obstruct the trajectory of a charged particle beam propagating in the column, the second coil set comprising at least one electrically energizable coil that, when electrically energized, produces collectively with the first coil set a magnetic field of a desired direction and magnitude effective for canceling at least a portion of the external magnetic field.

19. In a charged-particle-beam (CPB) optical system situated inside a column that extends along an optical axis, a device for reducing, by cancellation, a magnetic field external to the column that otherwise would extend to inside the column, so as to magnetically shield the CPB optical system from the external magnetic field, the device comprising:
an active-canceler coil set situated at an axial position relative to the column and adjacent a wall of the column so as not to obstruct a trajectory of a charged particle beam propagating in the column, the coil set comprising at least one individual coil that, when electrically energized, produces a respective magnetic field of a direction and magnitude sufficient for canceling at least a portion of the external magnetic field; and
a magnetic shield, made of an anisotropic magnetic material, situated outside the column.

20. The device of claim 19, wherein the coil set is a first coil set, the device further comprising a second active-canceler coil set adjacent the opening opposite the first coil set so as not to obstruct the trajectory of a charged particle beam propagating in the column, the second coil set comprising at least one individual coil that, when electrically energized, produces a respective magnetic field of a direction and magnitude sufficient, in concert with the magnetic field produced by the first coil set, for canceling at least a portion of the external magnetic field.

21. In a charged-particle-beam (CPB) optical system situated inside a column that extends along an optical axis, a device for shielding the CPB optical system from a magnetic field external to the column that otherwise would extend to inside the column, the device comprising at least one active-canceler coil set situated on or near the column so as not to obstruct a trajectory of a charged particle beam propagating in the column, each coil set being configured to be electrically energized and, when electrically energized, to produce a respective magnetic field oriented in a prescribed direction and having a magnitude sufficient to cancel at least a portion of the external magnetic field.

22. The device of claim 21, wherein the at least one coil set is oriented relative to the column to produce a respective magnetic field having a direction parallel to the optical axis.

23. The device of claim 21, wherein the at least one coil set is oriented relative to the column to produce a respective magnetic field having a direction that is oblique relative to the optical axis.

24. The device of claim 21, wherein the at least one coil set is oriented relative to the column to produce a respective magnetic field having a direction that is perpendicular to the optical axis.

25. The device of claim 21, further comprising a magnetic shield situated outside the column.

26. The device of claim 25, wherein the magnetic shield is made of an anisotropic magnetic material.

27. A charged-particle-beam (CPB) microlithography apparatus, comprising:
a CPB optical system extending along an optical axis;
a column containing the CPB optical system; and
a device for reducing, by cancellation, a magnetic field external to the column that otherwise would extend to inside the column, so as to magnetically shield the CPB optical system from the external magnetic field, the device comprising an active-canceler coil set situated at an axial position relative to the column and adjacent a wall of the column so as not to obstruct a trajectory of a charged particle beam propagating in the column, the coil set comprising at least one coil that can be electrically energized to produce a respective magnetic field of a direction and magnitude sufficient for canceling at least a portion of the external magnetic field.

28. A charged-particle-beam (CPB) microlithography apparatus, comprising:
a CPB optical system extending along an optical axis;
a column containing the CPB optical system;
an active-canceler coil set situated at an axial position relative to the column and adjacent a wall of the column so as not to obstruct a trajectory of a charged particle beam propagating in the column, the coil set comprising at least one coil that can be individually electrically energized to produce a respective magnetic field of a direction and magnitude sufficient for canceling at least a portion of the external magnetic field; and
a magnetic shield, made of an anisotropic magnetic material, situated outside the column.

29. A charged-particle-beam (CPB) microlithography apparatus, comprising:
a CPB optical system extending along an optical axis;
a column containing the CPB optical system; and
a device for reducing, by cancellation, a magnetic field external to the column that otherwise would extend to inside the column, so as to magnetically shield the CPB optical system from the external magnetic field, the device comprising at least one active-canceler coil set situated on or near the column so as not to obstruct a trajectory of a charged particle beam propagating in the column, each coil set being configured to be electrically energized and, when electrically energized, to produce a respective magnetic field oriented in a prescribed direction and having a magnitude sufficient to cancel at least a portion of the external magnetic field.

30. A method for magnetically shielding a charged-particle-beam (CPB) system comprising a CPB column and at least one chamber situated relative to an optical axis, the method comprising:
at an optical axial position relative to the system, disposing at least one active-canceler coil adjacent a wall of the system so as not to obstruct a trajectory of a charged particle beam propagating in the system, the at least one coil being electrically energizable; and
electrically energizing the at least one coil so as to cause the coil to produce a magnetic field that cancels at least a portion of an external magnetic field or a magnetic flux, present externally to the system and that otherwise would extend from outside the system to the optical axis within the system, to a desired distribution.

31. The method of claim 30, wherein the chamber is a reticle chamber or an object chamber.

32. The method of claim 30, wherein:
the system defines a magnetic gap; and
the coil is disposed adjacent the magnetic gap.

33. The method of claim 32, wherein the magnetic gap is an opening in the CPB column.

34. The method of claim 33, wherein the coil is a first coil, the method further comprising the steps of:
disposing a second coil adjacent the opening opposite the first coil so as not to obstruct the trajectory of a charged particle beam propagating in the system, the second coil being electrically energizable; and
while electrically energizing the first coil, electrically energizing the second coil so as to cause the coils to collectively produce a magnetic field for canceling at least a portion of an external magnetic field or a magnetic flux, present externally to the system and that otherwise would extend from outside the system to the optical axis within the system, to a desired distribution.

35. The method of claim 30, wherein the at least one active-canceler coil defines a coil set comprising multiple individual coils that are individually electrically energizable, the method further comprising the step of electrically energizing the coils so as to cause the coil set to produce a respective magnetic field of a desired direction and magnitude effective for canceling at least a portion of an external magnetic field or a magnetic flux, present externally to the system, that otherwise would extend from outside the system to the optical axis, thereby correcting a distribution of magnetic field within the system to a desired distribution.

36. The method of claim 30, further comprising the step of disposing a magnetic shield externally to the system, the magnetic shield being made of an anisotropic magnetic material.

37. The method of claim 36, wherein the magnetic shield is magnetically partitioned into partitions.

38. The method of claim 37, wherein the partitions extend in an axial direction.

39. The method of claim 36, wherein the magnetic shield is disposed so as to place the magnetic flux, present externally to the system, in a desired direction along the optical axis.

40. The method of claim 30, further comprising the step of disposing a magnetic shield externally to the system, the magnetic shield being partitioned into partitions extending in a predetermined direction for placing the magnetic flux, present externally to the system, in the predetermined direction.

41. The method of claim 40, wherein the predetermined direction is along the optical axis.

42. The method of claim 30, wherein the at least one coil is oriented relative to the column to produce a respective magnetic field having a direction parallel to the optical axis.

43. The method of claim 30, wherein the at least one coil is oriented relative to the column to produce a respective magnetic field having a direction that is oblique relative to the optical axis.

44. The method of claim 30, wherein the at least one coil is oriented relative to the column to produce a respective magnetic field having a direction that is perpendicular to the optical axis.

45. The method of claim 30, further comprising the step of disposing each coil of the coil set to position the optical axis within each coil.

46. The method of claim 30, further comprising the step of disposing each coil of the coil set to position the optical axis outside each coil.

47. In a charged-particle-beam (CPB) system including a CPB column and at least one chamber situated relative to an optical axis, a device for magnetically shielding the CPB system, comprising at least one active-canceler coil situated at an optical axial position adjacent a wall of the CPB system so as not to obstruct a trajectory of a charged particle beam propagating in the CPB system, the at least one coil being electrically energizable so as to cause the at least one coil to produce a magnetic field sufficient for canceling at least a portion of an external magnetic field or a magnetic flux, present externally to the CPB system and that otherwise would extend from outside the CPB system to the optical axis within the CPB system, to a desired distribution.

48. The device of claim 47, wherein the chamber is a reticle chamber or an object chamber.

49. The device of claim 47, wherein:
the CPB system defines a magnetic gap; and
the at least one coil is disposed adjacent the magnetic gap.

50. The device of claim 49, wherein the magnetic gap is an opening in the CPB column.

51. The device of claim 50, wherein the coil is a first coil, the device further comprising a second coil adjacent the opening opposite the first coil so as not to obstruct the trajectory of a charged particle beam propagating in the system, the second coil being electrically energizable so as to cause the first and second coils to collectively produce a magnetic field for canceling at least a portion of the external magnetic field or magnetic flux, present externally to the system and that otherwise would extend from outside the system to the optical axis within the system, to a desired distribution.

52. The device of claim 47, wherein the at least one active-canceler coil is configured as a coil set comprising multiple individual coils that are individually electrically energizable so as to cause the coil set to produce a respective magnetic field of a desired direction and magnitude effective for canceling at least a portion of an external magnetic field or a magnetic flux, present externally to the system, that otherwise would extend from outside the system to the optical axis, thereby correcting a distribution of magnetic field within the system to a desired distribution.

53. The device of claim 47, further comprising a magnetic shield disposed externally to the CPB system, the magnetic shield being made of an anisotropic magnetic material.

54. The device of claim 53, wherein the magnetic shield is magnetically partitioned into partitions.

55. The device of claim 54, wherein the partitions extend in an axial direction.

56. The device of claim 53, wherein the magnetic shield is disposed so as to place the magnetic flux, present externally to the system, in a desired direction along the optical axis.

57. The device of claim 47, further comprising a magnetic shield disposed externally to the CPB system, the magnetic shield being partitioned into partitions extending in a predetermined direction for placing the magnetic flux, present externally to the system, in the predetermined direction.

58. The device of claim 57, wherein the predetermined direction is along the optical axis.

59. The device of claim 47, wherein the at least one coil is oriented relative to the column to produce a respective magnetic field having a direction parallel to the optical axis.

60. The device of claim 47, wherein the at least one coil is oriented relative to the column to produce a respective magnetic field having a direction that is oblique relative to the optical axis.

61. The device of claim 47, wherein the at least one coil is oriented relative to the column to produce a respective magnetic field having a direction that is oblique relative to the optical axis.

62. The device of claim 47, wherein the at least one coil is oriented relative to the column to produce a respective magnetic field having a direction that is perpendicular to the optical axis.

63. The device of claim 47, wherein:
the at least one coil is configured as a coil set comprising multiple constituent coils; and
the coil set is disposed so as to position the optical axis within each coil.

64. The device of claim 47, wherein:
the at least one coil is configured as a coil set comprising multiple constituent coils; and
each coil set is disposed so as to position the optical axis outside each coil.

65. A charged-particle-beam (CPB) microlithography apparatus, comprising:
a CPB system including a CPB column and at least one chamber situated relative to an optical axis; and
a device for magnetically shielding the CPB system, comprising at least one active-canceler coil situated at an optical axial position adjacent a wall of the CPB system so as not to obstruct a trajectory of a charged particle beam propagating in the CPB system, the at least one coil being electrically energizable so as to cause the at least one coil to produce a magnetic field sufficient for canceling at least a portion of an external magnetic field or a magnetic flux, present externally to the CPB system and that otherwise would extend from outside the CPB system to the optical axis within the CPB system, to a desired distribution.
